(19) United States
(12) Patent Application Publication
(10) Pub. No.: US 2010/0197414 A1
(43) Pub. Date: Aug. 5, 2010

(54) Coupling of a constant velocity joint and a hub bearing unit of a motor vehicle wheel

(75) Inventor: Cristian Concu, Torino (IT)

Correspondence Address: Mark A. Ussai;SKF USA Inc., P.O. Box 332, 890 Forty Foot Road, Kulpsville, PA, 19443, US

(73) Assignee: Aktiebolaget SKF, Goteborg (SE)

(21) Appl. No.: 12/653,886

(22) Filed: Dec. 18, 2009

(30) Foreign Application Priority Data
Dec. 23, 2008 (EP) 08172926.1

(51) Int. Cl. F16D 3/84

(52) U.S. Cl. 464/178

(57) ABSTRACT

A driving ring is fixed to the rotatable hub of a hub bearing unit for providing torque transmission from an outer bell of a constant velocity joint. The bell has an outer tubular projection in telescopic relation with the driving ring. A first end surface of the tubular projection faces a second surface of a rotatable ring of the hub bearing unit. The driving ring and the tubular projection have mutually engaging splines. The hub and the constant velocity joint are releasably axially secured by a rigid cap received in the cavity of the bell and axially abutting against a shoulder within the bell, and a screw connecting the cap member to the hub in an axially tractive relationship. This axial traction causes axial compression of the annular seal which is fitted between the first and second surfaces and provides continuous sealing around the engaged splines.

### CROSS-REFERENCE TO RELATED APPLICATIONS

The present application claims priority to European Patent Application No. 08172926.1 filed on Dec. 23, 2008, the contents of which are incorporated fully herein by reference.

### BACKGROUND OF THE INVENTION

The present invention refers to the coupling between a constant velocity joint and a hub bearing unit of a motor vehicle wheel.

Couplings between constant velocity joints and hub bearing units are known, such as for example, the arrangements disclosed in US Patent Application No. 2002/0070506 A1 and U.S. Pat. No. 6,354,952. In each prior art arrangement, the hub of the wheel receives driving torque from the bell of a constant velocity joint through a straight splined coupling. A ring is fixed on the hub with an axial outer tooth that is telescopically inserted in a tubular projection with an inner axial tooth of the outer part or “bell” of the constant velocity joint. The toothed ring and the tubular projection are both provided with a respective circular groove into which an elastic, open ring (or circlip or Seeger ring) is fitted to axially lock the hub to the joint.

The above conventional arrangement, although being highly serviceable, has the drawback of limited sealing capacity. More specifically, the above-described elastic ring has two gripping arms at its ends that project through a slot formed at the axially outer end (or outboard end) of the joint bell. As depicted in FIG. 5 of US Patent Application No. 2002/0070506, a rubber sleeve covers the slot in order to seal it. The sleeve provides only a minimally efficient sealing that often allows water to penetrate, especially through the slot formed at the end of the joint bell, into the splined interface zone. Rust may then form at the interface of the splined coupling, which renders the disassembling operation of the hub-bearing unit from the constant velocity joint particularly difficult and shortens the life of the coupling members.

### SUMMARY OF THE INVENTION

It is a primary object of the invention to optimize the hermetic sealing action at the interface zone between the constant velocity joint and the hub bearing unit, closing the passages through which water may leak into the inner parts of the constant velocity joint and preventing water from accessing the splined coupling between the joint and the hub-bearing unit. Another object of the invention is to facilitate the assembly and disassembly of the hub-bearing unit to and from the constant velocity joint.

These objects are achieved, according to one aspect of the present invention, by a coupling arrangement that includes a rigid cap member received in the cavity of the bell member of the constant velocity joint and which axially abuts against a radial shoulder formed within the bell member. The hub and the constant velocity joint are releasably axially secured by a fastening means releasably connecting the cap to the hub in an axially tractive relationship (i.e., axial tension biases or pulls the cap generally toward the hub). The axial traction causes axial compression of an annular sealing gasket fitted between the bell member and the hub-bearing unit. As a result, a continuous sealing action is provided around the engaging splines of the bell member and the driving ring fixed to the hub.

A conventional straight splined coupling has a drawback due to the high noise that can be heard when the car is put into reverse, owing to the circumferential play between the splines on the bell of the constant velocity joint and the driving ring fixed on the hub.

It is a further object of the invention to overcome the above mentioned drawback concerning the noise. This other object is achieved, according to another aspect of the invention, by a coupling as defined in claim 10 or 11. The splined coupling is modified so that one of the two coupling members, i.e. the joint bell or the driving ring, has involute splines whereas the other member has straight axial splines. Due to the engagement of the different splines the relative angular or circumferential play between the constant velocity joint and the hub is taken up.

Preferred embodiments of the invention are set forth in the dependent claims.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is a partial axial cross sectional view of a first embodiment of an assembly comprising a constant velocity joint coupled to a hub-bearing unit;

FIG. 2 schematically depicts the layout of the splines of two members of the assembly of FIG. 1 coupled together in accordance with the invention; and

FIGS. 3 and 4 are cross sectional views of two variants of the invention with axial coupling components different from that of FIG. 1.

### DETAILED DESCRIPTION OF THE INVENTION

Certain terminology is used in the following description for convenience only and is not limiting. The words “right”, left”, “lower”, “upper”, “upward”, “down” and “downward” designate directions in the drawings to which reference is made. The words “inner”, “inwardly” and “outer”, “outwardly” refer to directions toward and away from, respectively, a designated centerline or a geometric center of an element being described, the particular meaning being readily apparent from the context of the description. As used herein, terms such as circumferential, radial, or axial are to be construed with respect to the central axis of rotation x of the hub. Further, as used herein, the words “connected” and “coupled” are each intended to include direct connections between two members without any other members interposed therebetween and indirect connections between members in which one or more other members are interposed therebetween. The terminology includes the words specifically mentioned above, derivatives thereof, and words of similar import.

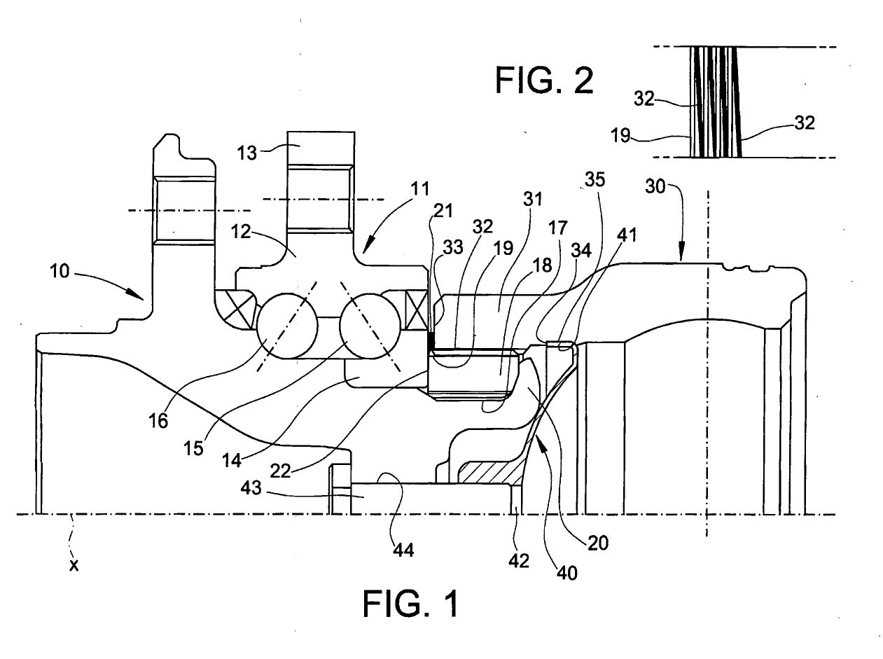

With reference initially to FIG. 1, a hub 10 for a driving wheel of a motor vehicle is rotatably mounted in the suspension standard (not shown) of the motor vehicle through a bearing unit 11 which includes an outer stationary race 12 having a flange 13 fixed to the standard through bolts (not shown). Locked onto the hub 10 is a rotatable inner bearing race 14 forming the inner raceway for one of the two sets of balls 15, 16 of the bearing unit.

The hub has a cylindrical surface 17 towards its axially outer end, onto which there is fixed a driving ring 18 with outer axial splines or teeth 19 for transferring the driving torque from the bell 30 of the constant velocity joint to the hub.

The driving ring 18 is securely axially locked against the inner bearing race 14 by cold forming, preferably by orbital rolling, of an end edge 20 of the hub. At an axially outer side, the joint bell 30 forms a tubular projection 31 within which the driving ring 18 is telescopically fitted. Formed within the tubular projection 31 are inner axial splines 32 which couple with the outer splines 19 of the driving ring 18.

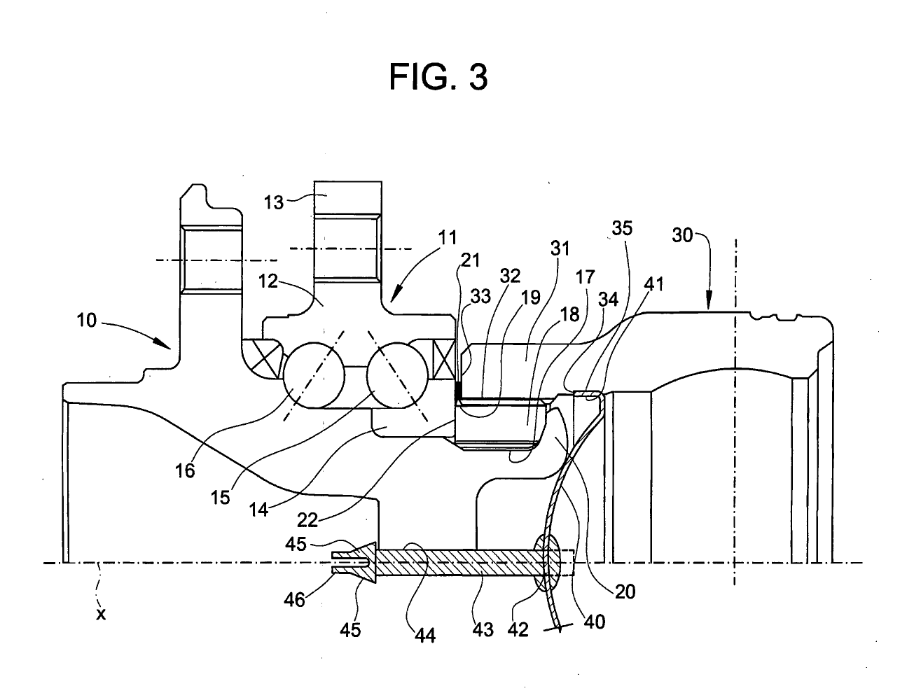

The two engaging splines are of different types. The outer splines 19 of the driving ring may be axially straight and the inner ones 32 of the joint bell may be involute, or vice-versa. The helical pitch of the involute splines has sufficient length to allow an initial effortless insertion of the driving ring 18 into the joint bell, preferably with a slight angular play between these two members. During insertion of the ring 18, the flanks of the straight axial splines and the involute splines come into contact, taking up the angular play between the hub and the joint bell. Preferably, the helical pitch of the involute splines is selected such that an amount of axial force is required to reach the fully coupled condition shown in the drawing figures. This condition is schematically shown in FIG. 2, where each involute spline (black) contacts, at a first end thereof, one of the two successive straight axial splines between which it is inserted and, at a second end, contacts the other axial spline.

An elastic sealing ring 21 is axially compressed between the axially outer face 33 of the bell 30 and the facing axially inner face 22 of the bearing race 14.

The hub and the constant velocity joint are axially removably connected by an inner cap 40 which is received within the cavity of the joint bell and encloses it towards the outside. The cap has a peripheral edge or skirt 41 axially abutting against a radial shoulder 34 formed within the cavity of the bell. The cap 40 provides a central threaded bore 42 within which a fastening element 43 (e.g., a screw) is threadably engaged within a bore 44 extending centrally through the hub and which is tightenable from the outside (i.e., externally tightenable). Tightening the fastening element 43 displaces the hub toward the joint and causes axial compression of the sealing ring 21, thereby assuring an efficient sealing at the interface between the hub and the constant velocity joint.

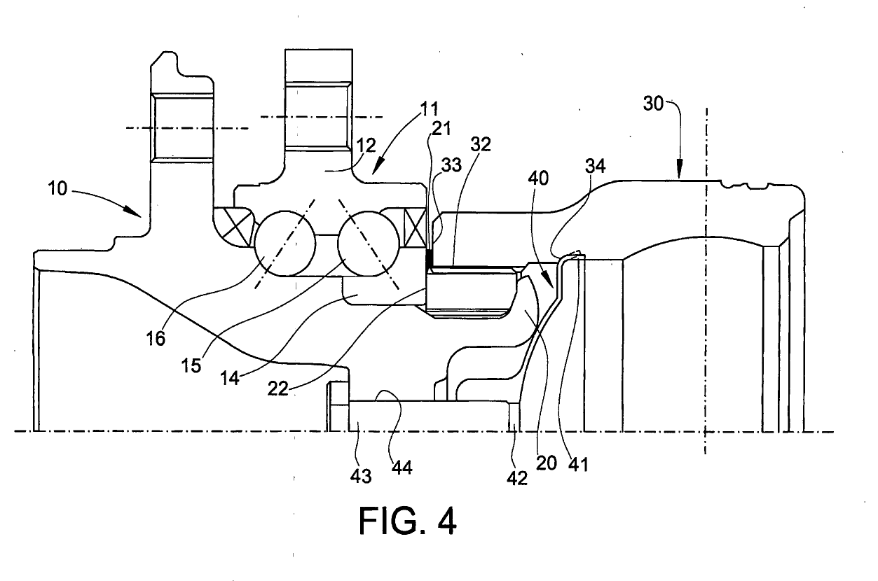

In the alternative embodiment of FIG. 3, the fastening element 43 is a pin of polymeric or plastic material, with an axially inner end clinched to the cap 40. The axially outer end of the pin is tapered and has wedge portions 45 that are inserted through the bore 44 and snap-locked onto the hub. The fastening pin 43 provides a pair of gripping appendages 46 which can be elastically displaced into proximity to each other by means of a hand tool.

The embodiment of FIG. 4 differs from the embodiment of FIG. 1 in the outline of the peripheral skirt 41. Whereas in FIG. 1 the skirt 41 is so folded as to have its free end facing the axially outer or outboard direction, in FIG. 4 the free end of the skirt 41 is facing the axially inner or inboard direction. The cap 40 is fitted within the joint bell from the right, preferably by means of a light force fit. The skirt 41 may have a conical or flared non-deformed free condition, as depicted in phantom in FIG. 4, so as to snap fit in an annular groove 35 formed in the bell cavity when the skirt 41 abuts against the shoulder 34. The skirt 41 may be circumferentially continuous or discrete, for example comprising a plurality of circumferentially adjacent fins.

As will be appreciated, the axial locking by means of the inner cap avoids the conventional circlip and the relevant slot in the bell for accessing the end gripping arms of the circlip. Hermetic sealing is ensured continuously around the splined coupling due to the ring being compressed between the bell joint and the bearing unit. This arrangement provides for compression of the sealing member and, to a certain extent, the sealing member is protected by two facing surfaces. Such an arrangement is more reliable over a period of time in comparison with a seal provided by a known rubber sleeve, which is relatively thin, less durable and subject to deterioration. It will also be appreciated that the absence of angular play between the hub and the joint bell eliminates the noise that is typically heard when a car is put into reverse gear with a splined coupling of conventional design.

Variations and modifications of the foregoing are within the scope of the present invention, and it will be appreciated by those skilled in the art that changes could be made to the embodiments described above without departing from the broad inventive concept thereof. For example, those skilled in the art will readily recognize that the invention can be equally implemented if the involute splines are formed on the driving ring and the straight ones on the joint bell. It is understood, therefore, that this invention is not limited to the particular embodiments disclosed, but it is intended to cover modifications within the spirit and scope of the present invention as generally defined in the appended claims.

I claim:

1. A coupling arrangement between a hub bearing unit for a motor vehicle wheel and an associated constant velocity joint, the hub bearing unit including a rotatable hub to which a driving ring is fixed for providing torque transmission to the hub from an outer, rotatable bell member of the constant velocity joint;
the bell member having a tubular projection in telescopic relation with the driving ring, with an first end surface of the tubular projection facing a second surface of a rotatable member of the hub bearing unit;
the driving ring and the tubular projection having respective outer and inner mutually engaging splines;
characterized in that the hub and the constant velocity joint are releasably axially secured by:
a rigid cap member received in the cavity of the bell member and axially abutting against a radial shoulder formed within the bell member; and
a fastening means releasably connecting the cap member to the hub in an axially tractive relationship;
whereby the axial traction causes axial compression of an annular sealing member which is fitted between said first and second surfaces and provides continuous sealing action around the engaging splines.

2. A coupling arrangement as recited in claim 1, wherein the cap member forms a peripheral skirt axially abutting against the radial shoulder within the cavity of the bell member.

3. A coupling arrangement as recited in claim 1, wherein the fastening means include a threaded member threadably engaged with a central threaded bore of the cap member and disposed within an axial bore extending centrally through the hub, the threaded member being externally tightenable.

4. A coupling arrangement as recited in claim 1, wherein the fastening means include a pin, the pin being one of connected with the cap member and integrally formed with the cap member, the pin being disposed within an axial bore extending centrally through the hub and having a snap mounting means providing quick connection to the hub.

5. A coupling arrangement as recited in claim 4, wherein the pin has an axially outer end with a pair of gripping appendages projecting axially outwardly of the bore of the hub so as to be elastically brought near to one another by means of a tool in order to disengage the snap mounting means from the hub.

6. A coupling arrangement as recited in claim 1, wherein the cap member closes the internal cavity of the bell member towards the outside.

7. A coupling arrangement as recited in claim 2, wherein the peripheral skirt is force fitted into an annular groove formed in the bell cavity.

8. A coupling arrangement as recited in claim 2, wherein the peripheral skirt has a free end facing an axially outer direction.

9. A coupling arrangement as recited in claim 2, wherein the peripheral skirt has a free end facing an axially inner direction.

10. A coupling arrangement as recited in claim 1, wherein the splines of the driving ring are axially straight splines, and the splines of the tubular projection are involute splines.

11. A coupling arrangement as recited in claim 1, wherein that the splines of the tubular projection are axially straight splines, and the splines of the driving ring are involute splines.
